(19) United States
(12) Patent Application Publication
(10) Pub. No.: US 2007/0178820 A1
(43) Pub. Date: Aug. 2, 2007

(54) FISH CLEANING AND FILLETING DEVICE

(76) Inventor: Vincent Tylman, Lake Oswego, OR (US)

Correspondence Address: FASTH LAW OFFICES (ROLF FASTH), 26 PINECREST PLAZA, SUITE 2, SOUTHERN PINES, NC, 28387-4301, US

(21) Appl. No.: 11/623,868

(22) Filed: Jan. 17, 2007

Related U.S. Application Data
(60) Provisional application No. 60/760,135, filed on Jan. 19, 2006.

(51) Int. Cl. A22C 25/06

(52) U.S. Cl. 452/194

(57) ABSTRACT

The fish-cleaning and fish-filleting device has four flat sheets that are configured in such a way that they will lock together to form either a fish-cleaning and/or a fish filleting table.

### PRIOR APPLICATION

This patent application claims priority from US patent application Ser. No. 60/760,135, filed 19 Jan. 2006.

### FIELD OF INVENTION

The invention relates to a device that provides a superior method of fish cleaning and filleting with automatic removal of the offal created.

### BACKGROUND INFORMATION AND SUMMARY OF INVENTION

There are a number of fish cleaning tables available in the marketplace today, however, several fundamental shortcomings are present in the available tables. These tables do not make adequate provision to secure the fish, making them potentially hazardous. None of these tables cradle the fish in such a manner as to prevent it from sliding off of the table. Also, they have not been designed to self-clear the offal and often can become unsanitary because of difficulty of proper cleaning. Further, no known current fish-cleaning tables breakdown into flat sheets for easy storage. The table presented in this invention corrects all of these shortcomings and adds additional features.

This device is primarily intended to be used or mounted on a boat. However, it may also be used on a dock, pier or almost any other location. It is designed to make use of a universal gimbal mounting device that slides into the fish pole holders found on most fishing boats, however, other methods of mounting may be used.

Another problem is that any device that is exposed to fish offal and salt water is subject to corrosion. To overcome this problem, this device is made 100% percent from a plastic(s) that is impervious to corrosion; however, other materials may also be used. Further, there are no metallic fasteners used in the device's construction that could in time corrode or be lost. A second benefit from this design is that the device can be assembled and broken down without the use of any tools.

The present invention is also multifunctional in that it can be used as or as a horizontal filleting or utility table. The present invention further distinguishes itself from present art by allowing the user, quickly and without the use of tools, to change the components from cleaning table to filleting table and back again without the use of tools. This is accomplished by moving the narrow flat surface between the rearward slots in the vertical end supports and the forward slots and adjusting the gimbal so that the angle is suitable for cleaning or filleting.

Further, the device can offer the user the option of setting the cradle size to fit both small and large fish by providing a secondary slot for the narrow flat surface.

### BRIEF DESCRIPTION OF THE DRAWINGS

FIG. 1-A is a perspective view of the device in the fish-cleaning configuration.

FIG. 1-B is a perspective view of the device in the fish-cleaning configuration with the auxiliary end stop in position.

FIG. 2 is a perspective view of the device in the fish-filleting configuration

FIG. 3 is an exploded view of the device in the fish-cleaning configuration showing how the device comes apart.

FIG. 4 is a view of the device as collapsed for storage.

FIG. 5-A is a side view of the left-hand end support member showing the dado slots where the small board member installs and the angular relationship between the narrow flat surface and the wide flat surface.

FIG. 5-B is a cross section of the left-hand end support section showing the shape of the slots or dados.

FIG. 6 is a side view of the device showing how the fish is cradled between the narrow flat surface and the wide flat surface.

FIGS. 7A, B and C show an alternative device for affixing the narrow and wide flat members to the end support members using “T” slots.

### DETAILED DESCRIPTION

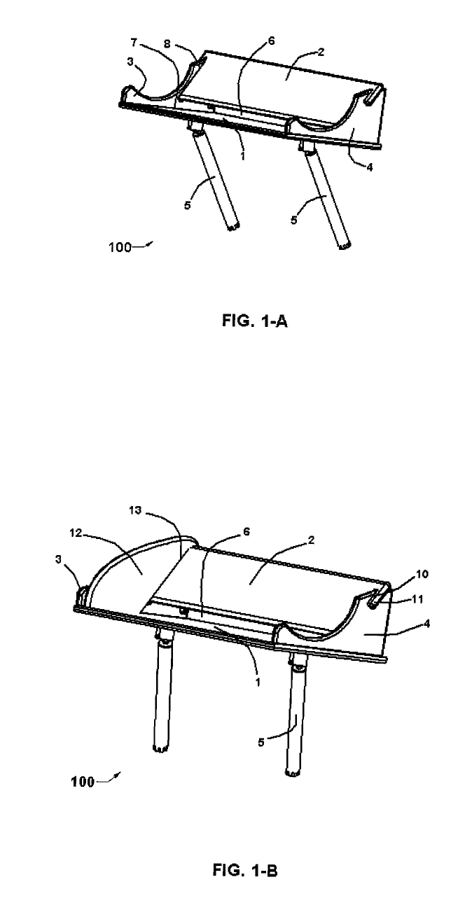

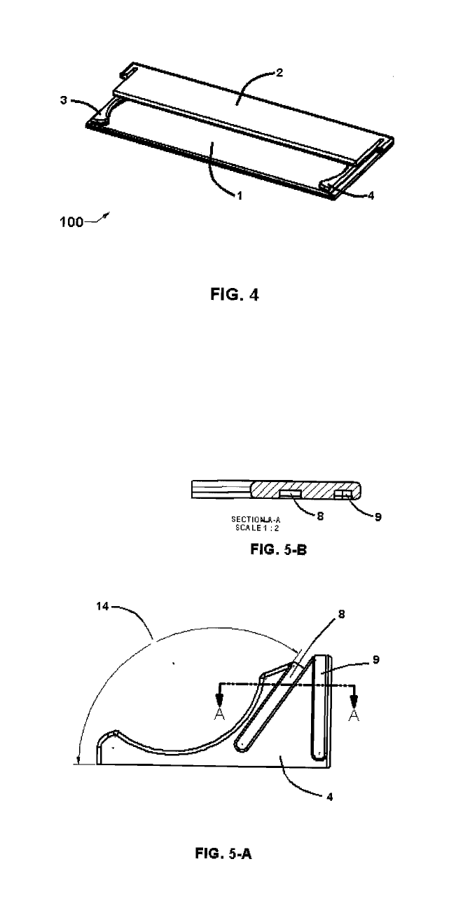

With reference to FIGS. 1-7, the present invention is a device 100 consisting of at least two flat panel surfaces 1,2 disposed to each other at an angle 14. The flat surfaces are separated from each other so there is a space or distance 6 between the two surfaces. The two flat panel surfaces 1,2 are held in position by two vertical end support members 3, 4. The support members are slotted at slots 8, 9 to receive the narrow flat surface 2. The preferred configuration of the slots 8, 9 is a simple dado shape as best shown in FIGS. 5-A and 5-B. However, it is to be understood that any number of suitable methods of attachment may be used such as dovetails, holes and pins, hinges, etc. In the shown configuration, the wide flat member is attached to the end support members through the use of a hinge and the narrow flat surface is held in place by the dado slots in the end support members and the “fingers” 11 on the narrow flat member. It is understood that attachment methods other than the “fingers” can be used to hold the small flat member securely in the dado slots of the end support members. The method of construction of the present invention allows the entire device to be assembled and disassembled without the need for tools.

The preferred configuration of the flat surfaces is to have one surface 2 be approximately one-half the width of the other surface 1. The narrower surface 2 is disposed above the wider surface 1 at the angle 14 and spaced above the wider surface the distance 6 that is sufficient to allow the offal from the fish being cleaned to slip between the two surfaces 1, 2 and slide down the wider surface 1 either overboard or into a waste container.

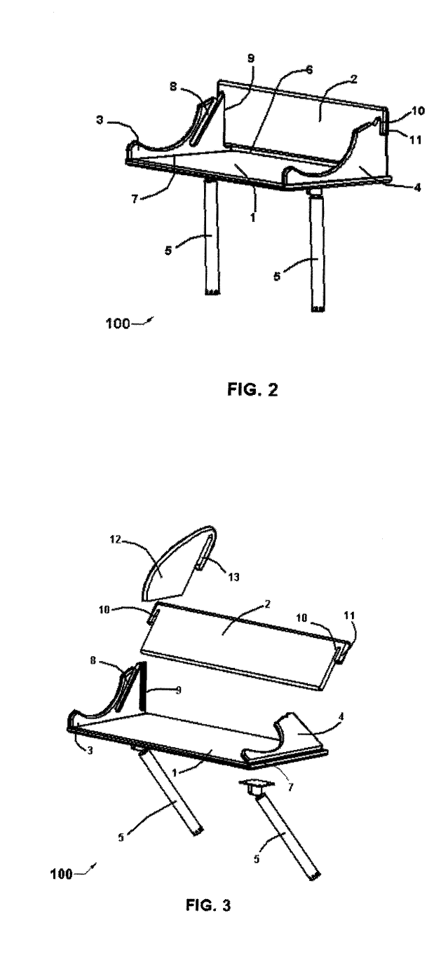

The angle 14 between the two surfaces 1,2 forms a cradle or trough that holds the fish and prevents it from sliding off of the table. When desired the auxiliary end stop 12, can be slid over the narrow flat surface 2 to prevent the fish from sliding longitudinally from the trough 106 formed by flat members 1 and 2. The preferred angle 14 between the two flat surfaces 1, 2 is approximately 112 to 135 degrees. After the fish has been cleaned and/or gutted, the device can be converted to a more horizontal filleting or utility table, as best shown in FIG. 2, by moving the narrower of the flat surfaces 2 from the more forward position 8 in the vertical end support members to the more rearward position 9 in the vertical end support members 3, 4. A support gimbal 5 is then loosened and the wider flat surface is adjusted to more horizontal position providing a larger and more level surface for filleting the fish. The device 100 may then also be used as table for holding dishes, etc. The entire table 100 is mounted on the adjustable gimbal(s) 5 that may slide into the fish pole holder(s) found on most fishing boats, however, other types of mounting methods may also be used

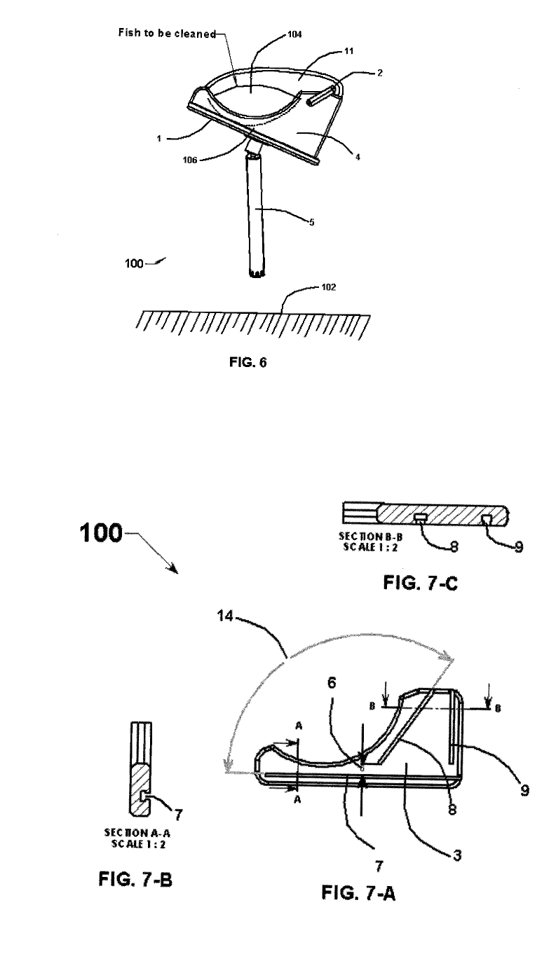

FIG. 6 shows the device 100 in the fish cleaning position so both panels 1 and 2 are sloping relative to a horizontal plane 102 to form a cradle 106 in which the fish 104 may rest during the cleaning process. For example, the first panel may slope at an angle alpha relative to the horizontal plane. FIG. 5-A shows the device 100 in the fish filleting position since panel 1 is substantially parallel to the horizontal plane and the second panel is inserted into the slot 9.

While the present invention has been described in accordance with preferred compositions and embodiments, it is to be understood that certain substitutions and alterations may be made thereto without departing from the spirit and scope of the following claims.

I claim:

1. A fish-cleaning and fish-filleting device comprising:
two or more flat members two of which are placed at an angle to each other so as to form a cradle that secures the fish in position.

2. The device according to claim 1 wherein the two members that are placed at an angle to each other are also spaced apart a sufficient distance to allow the offal and waste material from the cleaned fish to pass between them.

3. The device according to claim 1 wherein the two flat members forming the fish cradle having one member with approximately twice a width of the other member allowing the wide member to carry waste and offal to a rear of the device for disposal

4. The device according to claim 1 wherein the two members placed at an angle and spaced apart from each other are held securely in position by two vertical end support members.

5. The device according to claim 4 wherein the two vertical end support members allows are adapted to move a narrow flat member to either a forward fish cleaning position or a rearward fish filleting position.

6. A method for cleaning and filleting a fish, comprising:
providing a device having a first panel and a second panel, the device having side walls, the side walls having a first slot defined therein for receiving the first panel and second and third slots defined therein for receiving the second panel;
inserting the second panel in the second slot so that an obtuse angle is formed between the first and second panels and so that a space is formed between an upper surface of the first panel and a bottom end of the second panel;
cleaning the fish disposed in a cradle formed between the first and second panels;
inserting the second panel in the third slot; and filleting the fish.

7. The method according to claim 6 wherein the method further comprises sloping the first panel at an angle alpha relative to a horizontal plane when cleaning the fish.

8. The method according to claim 7 wherein the method further comprises moving the first panel before filleting the fish so that the first panel is substantially parallel to the horizontal plane.

9. The method according to claim 7 wherein the method further comprises permitting offal from the fish to slide on the first panel and through the space defined between the first and second panel.
